(19) United States
(12) Patent Application Publication
(10) Pub. No.: US 2025/0110675 A1
(43) Pub. Date: Apr. 3, 2025

(54) IMAGE PROCESSING APPARATUS, AND METHOD OF CONTROLLING IMAGE PROCESSING APPARATUS

(71) Applicant: CANON KABUSHIKI KAISHA, Tokyo (JP)

(72) Inventor: HIROYOSHI YOSHIDA, Tokyo (JP)

(21) Appl. No.: 18/890,026

(22) Filed: Sep. 19, 2024

(30) Foreign Application Priority Data
Sep. 28, 2023 (JP) 2023-168560

(51) Int. Cl. G06F 3/12; H04N 1/00

(52) U.S. Cl. CPC G06F 3/1273; G06F 3/1207; G06F 3/1259; H04N 1/00477; H04N 1/00482; H04N 1/00824

(57) ABSTRACT

An image processing apparatus includes: an execution unit configured to execute a job; a first obtainment unit configured to obtain character string information including a predetermined character string; a second obtainment unit configured to obtain setting information corresponding to the executed job; a saving unit configured to, in a case where a destination included in the setting information is a destination corresponding to the predetermined character string, save the setting information including the destination as job history information, and in a case where at least one or more destinations included in the setting information are a destination not corresponding to the predetermined character string, save the setting information not including the destination not corresponding to the predetermined character string as the job history information; and a display control unit configured to display the job history information in a predetermined display region.

### BACKGROUND

### Field

The present disclosure relates to an image processing apparatus, and a method of controlling the image processing apparatus.

### Description of the Related Art

For an image processing apparatus, a function that allows for automatic saving of setting information (job setting information) corresponding to an executed job and setting of a new job based on the saved job setting information has been provided.

In Japanese Patent Laid-Open No. 2004-135213 (PTL 1), a method of automatically saving job setting information according to the number of times the job setting information is set.

However, in PTL 1, there is a possibility of occurrence of “wrong transmission” in which a job is transmitted to a wrong destination by diverting the saved job setting information.

### SUMMARY

An image processing apparatus according to an aspect of the present disclosure includes: an execution unit configured to execute a job; a first obtainment unit configured to obtain character string information including a predetermined character string; a second obtainment unit configured to obtain setting information corresponding to the executed job; a saving unit configured to, in a case where a destination included in the setting information is a destination corresponding to the predetermined character string, save the setting information including the destination as job history information, and in a case where at least one or more destinations included in the setting information are a destination not corresponding to the predetermined character string, save the setting information not including the destination not corresponding to the predetermined character string as the job history information; and a display control unit configured to display the job history information in a predetermined display region.

Further features of the present invention will become apparent from the following description of exemplary embodiments with reference to the attached drawings.

### BRIEF DESCRIPTION OF THE DRAWINGS

FIG. 1 is a block diagram describing a configuration of an image processing apparatus;

FIG. 2 is an exterior view of a display operation unit;

FIG. 3 is a flowchart from activation of the image processing apparatus to displaying of a screen of a login user;

FIG. 4 is a schematic view of an authentication screen;

FIGS. 5A to 5G are schematic views of a home screen;

FIG. 6 is a flowchart of execution of a job;

FIGS. 7A to 7D are schematic views of a transmission screen;

FIG. 8 is a schematic view of an automatically saved domain registration screen;

FIG. 9 is a flowchart of automatically registered destination determination;

FIGS. 10A to 10D are diagrams illustrating a data table of job setting;

FIG. 11 is a flowchart of generation of displayed contents in a case of adding a job history;

FIGS. 12A to 12F are diagrams illustrating a data table of combined history;

FIG. 13 is a flowchart illustrating details of setting value text generation processing;

FIG. 14 is a flowchart of updating of the displayed contents of the job history;

FIG. 15 is a flowchart in a case of calling an application from the combined history;

FIG. 16 is a flowchart of automatically registered destination determination;

FIG. 17 is a flowchart in a case of calling the application from the combined history; and

FIG. 18 is a flowchart in a case of calling the application from the combined history.

### DESCRIPTION OF THE EMBODIMENTS

Embodiments of the present disclosure are described below in detail with reference to the appended drawings. Note that, the following embodiments are not intended to limit the present disclosure according to the scope of claims.

### Embodiment 1

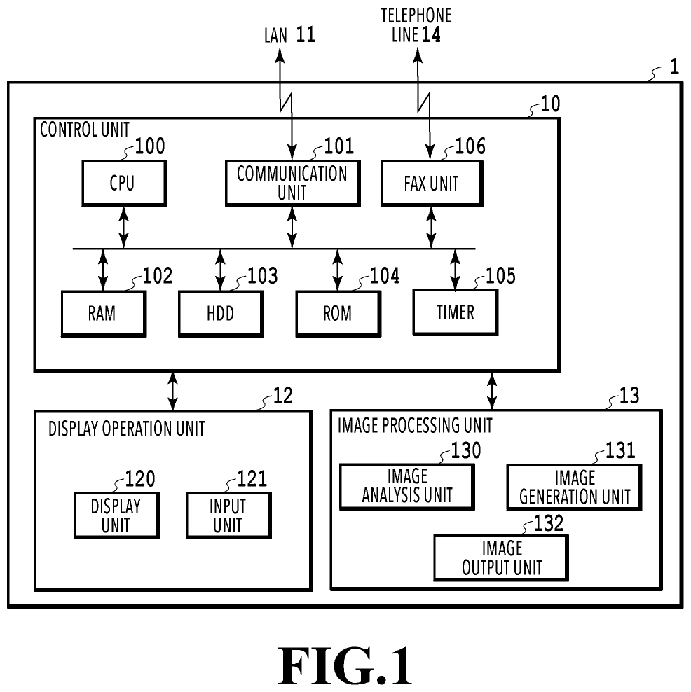

FIG. 1 is a block diagram describing a configuration of an image processing apparatus 1 according to the present embodiment. The image processing apparatus 1 includes a control unit 10, a display operation unit 12, and an image processing unit 13. Note that, the image processing apparatus 1 is a printing apparatus (a printer), for example. The printing apparatus indicates an apparatus including a printing device having a printing function to print information on a printing medium by using a printing material. Additionally, for example, the image processing apparatus 1 may be an apparatus that additionally includes a reading device that reads an image on a document and functions as a copier or may be a multi-function peripheral (MFP) to which another function is added. In addition, for example, various devices such as a personal computer (PC), a smartphone, and a digital camera may be applied as the image processing apparatus 1 of the present embodiment.

The control unit 10 performs an operation control of each unit in the image processing apparatus 1. The control unit 10 includes a CPU 100, a communication unit 101, a RAM 102, an HDD 103, a ROM 104, a timer 105, and a FAX unit 106. The CPU 100 controls overall the control unit 10. The communication unit 101 transmits and receives data through a LAN 11. The RAM 102 provides a system working memory to allow the CPU 100 to operate. The HDD 103 is a hard disk drive and may be a storage medium such as a magnetic disk, optical media, or a flash memory, for example. The HDD 103 can store document data, setting data, or the like. Additionally, the HDD 103 may not be within the image processing apparatus 1. An external server, PC, or the like may be used as a saving apparatus via the communication unit 101. The ROM 104 is a boot ROM and stores a boot program of a system. The CPU 100 deploys a program installed in the HDD 103 to the RAM 102 by the boot ROM in the ROM 104 and performs various controls based on the program. The timer 105 measures the time according to an instruction of the CPU 100, and once the instructed time is passed, the timer 105 notifies the CPU 100 of the time passage by interruption and the like. The FAX unit 106 transmits and receives fax data through a telephone line 14.

The display operation unit 12 is controlled by the control unit 10. Additionally, the display operation unit 12 includes a display unit 120 and an input unit 121. The display unit 120 is a display to display information of the image processing apparatus to a user. The display unit 120 is display-controlled by the control unit 10. The input unit 121 receives an input from the user through an interface such as a touch panel, a mouse, a camera, a sound input, or a keyboard, for example.

The image processing unit 13 is controlled by the control unit 10. Additionally, the image processing unit 13 includes an image analysis unit 130, image generation unit 131, and an image output unit 132. The image analysis unit 130 analyzes a structure of a document image and extracts necessary information from an analysis result. The image generation unit 131 reads (for example, scans) the document to digitalize an image of the document and generate image data and then stores the image data in the HDD 103. Additionally, the image generation unit 131 can also generate document image data in a different format by using the information analyzed by the image analysis unit 130. The image output unit 132 outputs the image data stored in the HDD 103 and the like. This outputting method may include, for example, printing the image data of the document on a sheet, transmitting the image data to an external device, a server, or a facsimile apparatus in network connection via the communication unit 101, and saving the image data in the storage medium.

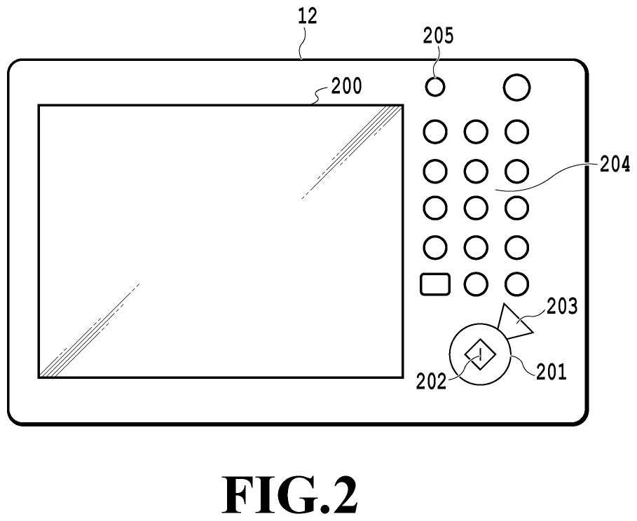

FIG. 2 is an exterior view of the display operation unit 12 according to the present embodiment. A touch panel 200 is a liquid crystal display unit in this case, and a touch panel sheet is attached on a liquid crystal. Additionally, the touch panel 200 displays an operation screen and a soft key, and in a case where a displayed key is pressed, the touch panel 200 also transmits position information thereof to the CPU 100. Accordingly, the touch panel 200 in this case functions as the display unit 120 in FIG. 1 and functions also as the input unit 121.

Next, various keys or buttons operated by the user are described. A start key 201 is used in a case of instructing start of an operation of reading the document and the like. There is an LED 202 having two colors, green and red, in a central portion of the start key 201, and whether the start key 201 is in an available state is indicated depending on the colors. A stop key 203 has a function of stopping an operation in operation. A numeric keypad 204 includes buttons of numbers and characters and instructs setting of scanning, screen switching of the touch panel 200, or the like. A user mode key 205 is pressed (selected) in a case of setting a device.

Hereinafter, in a case where “a screen is displayed” is mentioned, it means that the CPU 100 calls corresponding screen display data and screen control program from the HDD 103 or the RAM 102 and displays the screen display data on the display unit 120. Likewise, hereinafter, in a case where an operation such as “the user presses ○○” is performed on the touch panel and the various keys, it means that the CPU 100 performs processing that should be executed based on the position information notified from the input unit 121 and the screen control program from screen control data.

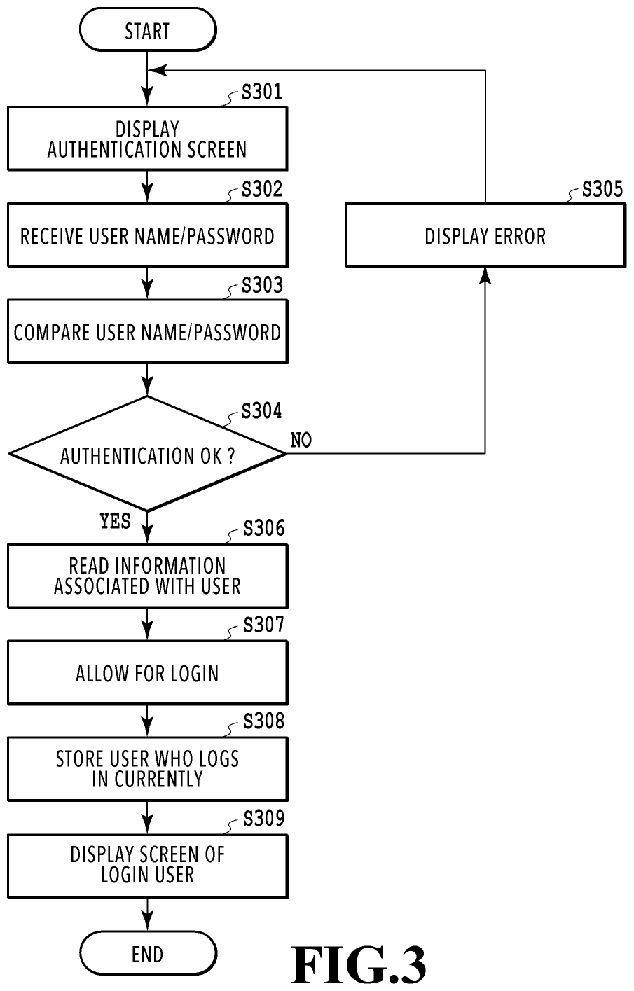

FIG. 3 is a flowchart of displaying a screen of a login user that is activated in a case where the image processing apparatus 1 detects an action such as putting of the document on a document stacking unit of the image processing apparatus 1 by the user or touching on the display operation unit 12, according to the present embodiment 1. The processing in the present flowchart is implemented with the CPU 100 of the image processing apparatus 1 deploying the program stored in the ROM 104 to the RAM 102 to execute. Additionally, the processing in the present flowchart is started in a case where the image processing apparatus 1 detects putting (placing) of the document on the document stacking unit of the image processing apparatus 1 or detects an action such as touching of the display operation unit 12. Note that, a sign “S” in each description of the processing in the present flowchart means that it is a step in the flowchart, and the same applies to the subsequent drawings.

In S301, in a case where setting to identify the user is ON, the CPU 100 of the image processing apparatus 1 displays an authentication screen on the touch panel 200 after a main body is activated.

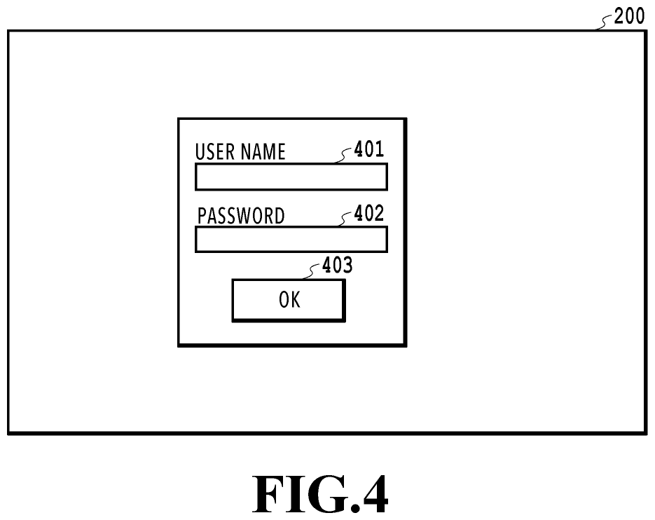

FIG. 4 is an example of the authentication screen displayed on the touch panel 200. The authentication screen includes regions to input a user name 401 and a password 402. In S302, the CPU 100 of the image processing apparatus 1 receives inputs of the user name and the password registered by the user in advance. Additionally, the CPU 100 receives pressing of an OK button 403.

In S303, the CPU 100 compares a user name and a password saved in the HDD 103 to the inputted user name and password. Note that, the user name and the password may be saved outside such as an external server. In S304, the CPU 100 performs authentication by using the inputted user name and password. That is, whether the user name and the password match the inputted user name and password is determined. If it is determined that they match (authentication OK), the CPU 100 allows the process to proceed to S306. If it is determined that they do not match (authentication NG), the CPU 100 allows the process to proceed to S305. Note that, in a case where the user and the password are saved outside, the authentication may be performed by establishing communication with the outside for the authentication. In S305, the CPU 100 displays an error message on the touch panel 200 and then displays the authentication screen again. In S306, the CPU 100 calls information associated with the user.

In S307, once the calling is completed, the CPU 100 allows the user to log in. In S308, the CPU 100 saves the user who logs in currently in the HDD 103. In S309, the CPU 100 displays a home screen corresponding to the called information of the login user on the touch panel 200. Thereafter, the CPU 100 ends the processing in the present flowchart.

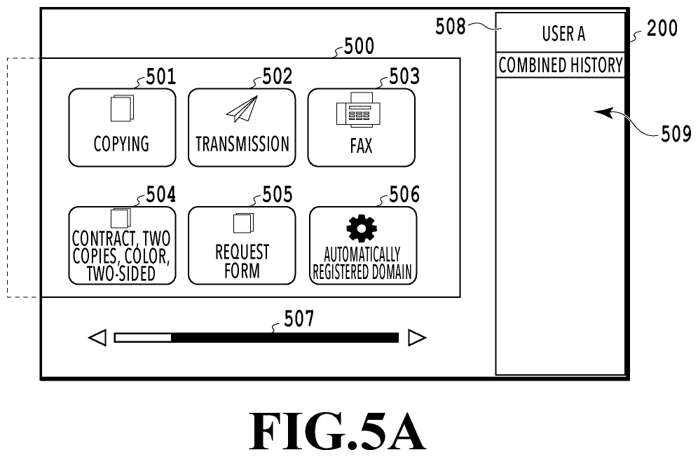

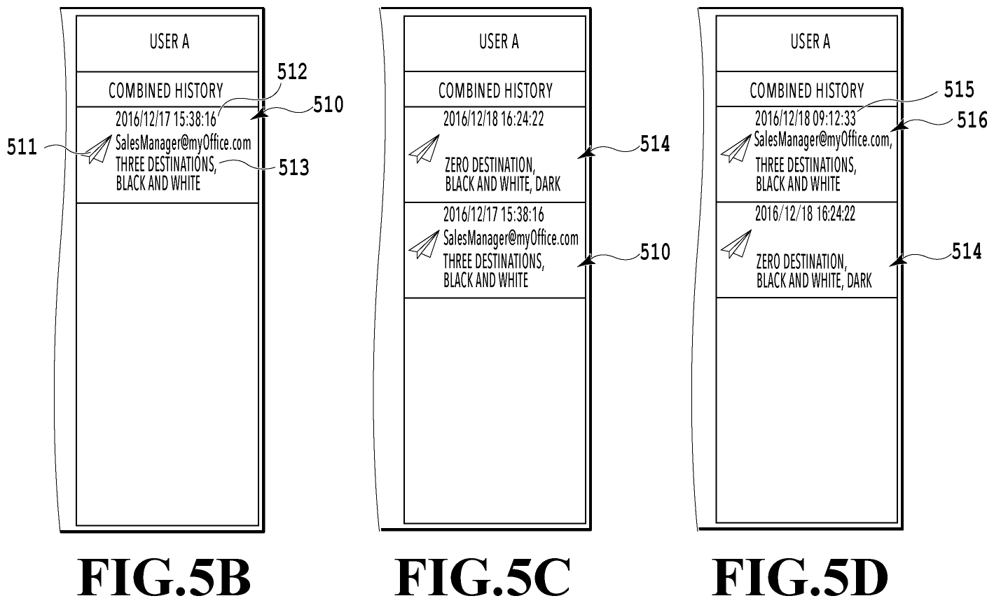

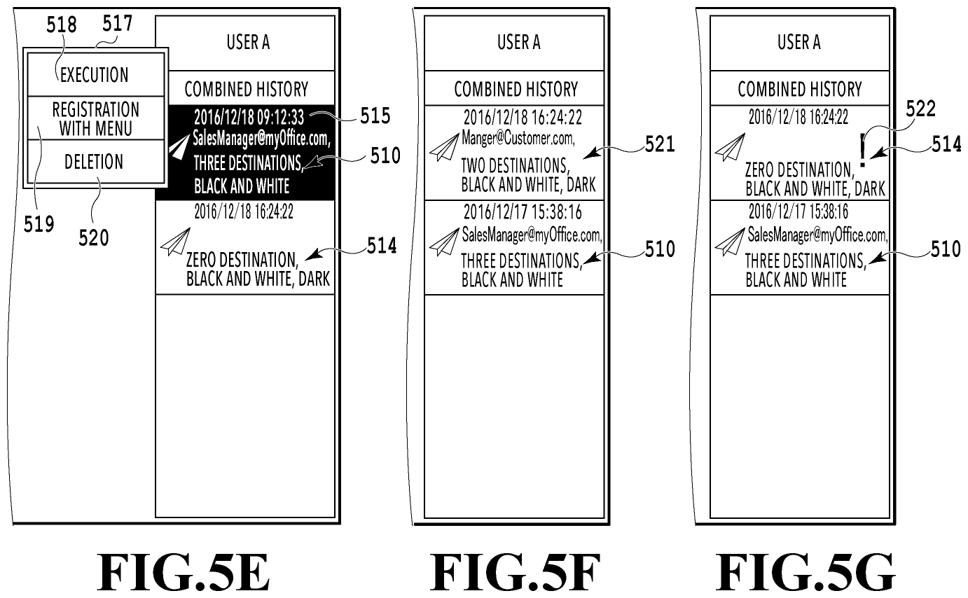

FIGS. 5A to 5G are diagrams illustrating the home screen displayed on the touch panel 200 in the present embodiment. FIG. 5A is a home screen reflecting setting of the login user. The home screen of the login user displays a menu 500 to activate (select) each application (function). The menu 500 includes application buttons 501 to 503 to activate an application with a default value and custom buttons 504 and 505 to activate an application with a setting value set in advance. These buttons are displayed in a layout customized by the user based on the information of the login user. Additionally, for example, a region in which the custom buttons 504 and 505 are arranged may be a region in which a my button, which is displayed on only a personal home screen, and a common button, which is displayed commonly on a home screen of another user as well, can be arranged depending on the setting. An automatically registered domain button 506 is a button to call a screen to perform automatically registered domain setting described later. A slider bar 507 indicates that this menu 500 can be slid and moved. Additionally, with the slider bar slid, an arrow pressed, or inside of the menu 500 flicked, the CPU 100 receives the input and calls and displays the application button or the custom button registered with the next region from the HDD 103. The user who logs in currently is displayed on a user name display region 508 at the upper right of the screen. Currently, a case where a “user A” logs in is illustrated. A combined history display region 509 is a region to automatically register and display histories of setting information of jobs (setting of jobs) of multiple applications executed by the image processing apparatus 1. In a case where the authentication is used, the combined history display region 509 displays only the histories of the setting information of the jobs (job history information) executed by the login user. In a case where the job is never executed, or in a case where the history in the combined history display region 509 is deleted, the combined history display region 509 is in an empty state as illustrated in FIG. 5A. A subsequent operation or displaying in the combined history display region 509 is executed by the CPU 100 based on a program of the job history saved in the HDD 103. Additionally, the data used in the job history is saved in the RAM 102 and the HDD 103. In FIGS. 5B to 5F used in the descriptions below, the user name display region 508 and the combined history display region 509 within the screen displayed by the touch panel 200 are illustrated.

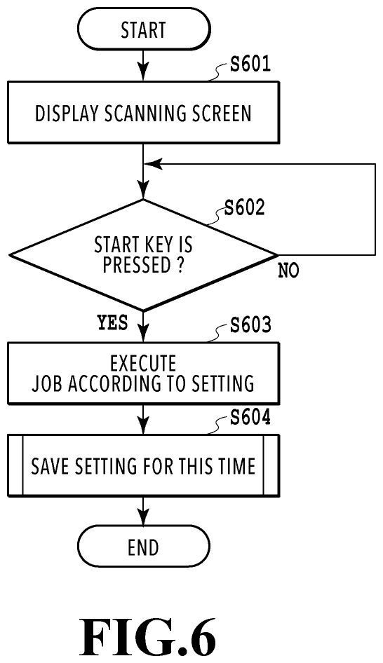

FIG. 6 is a flowchart in a case where the job is executed in the present embodiment. The processing in the present flowchart is started with the image processing apparatus 1 detecting that the user selects transmission 502 in FIG. 5A. Note that, in the present embodiment, the transmission indicates to transmit the data scanned by the image processing apparatus 1 to the outside.

In S601, in response to the selection of the transmission 502, the CPU 100 of the image processing apparatus 1 calls an application to perform transmission from the HDD 103 and displays a transmission screen 700. Note that, in the present embodiment, it is described that the transmission 502 is to transmit the data read by a scanning function to a transmission destination. That is, it is possible to restate that the transmission application is a scanning application. Additionally, although the transmission screen 700 is displayed since the transmission 502 is selected in the present embodiment, in a case where another application is selected, displaying of settings according to the application is performed.

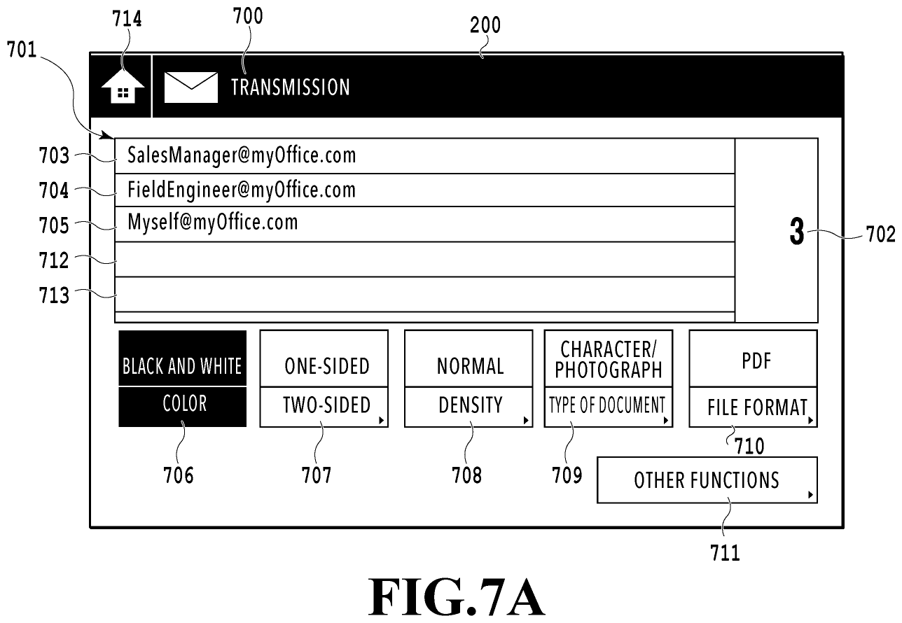

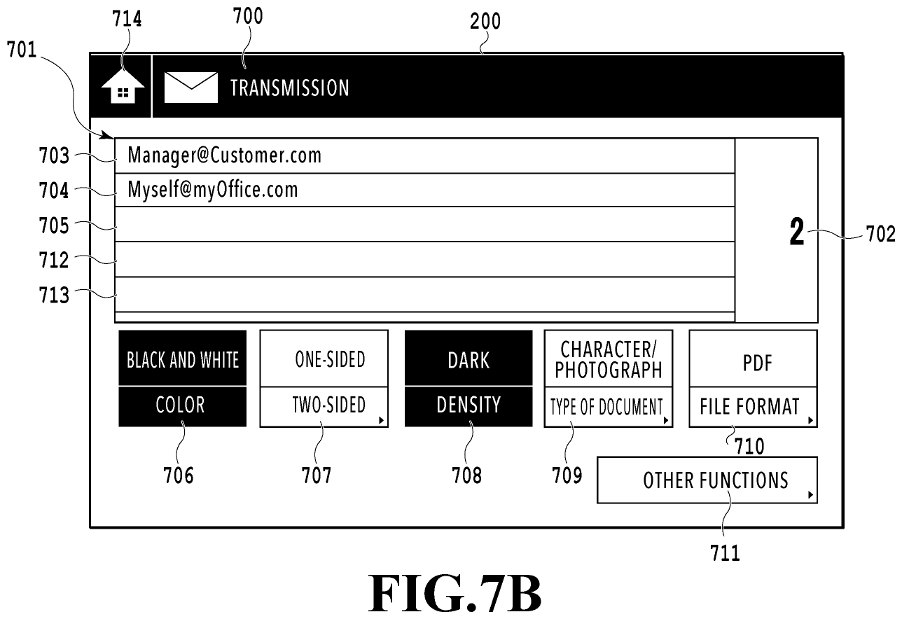

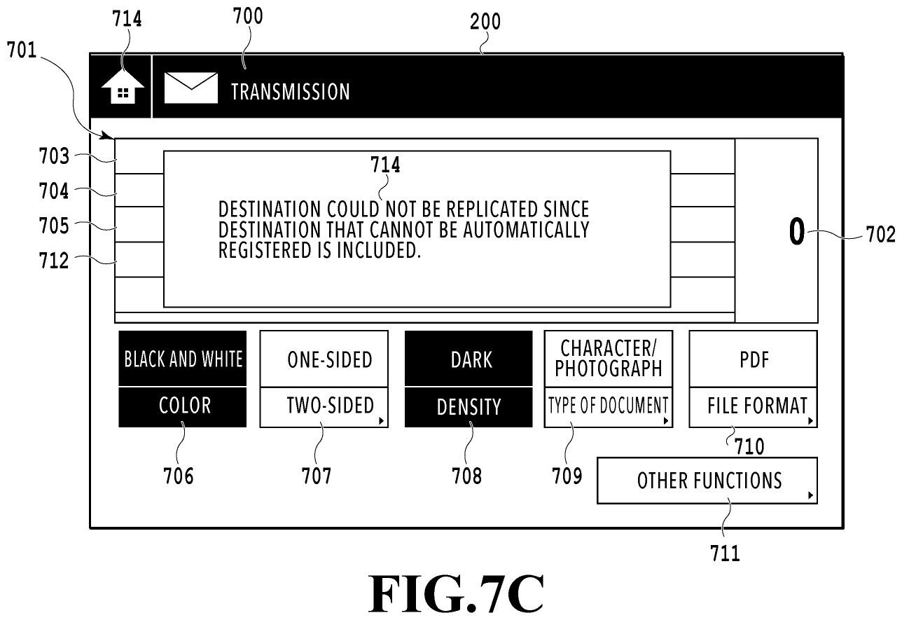

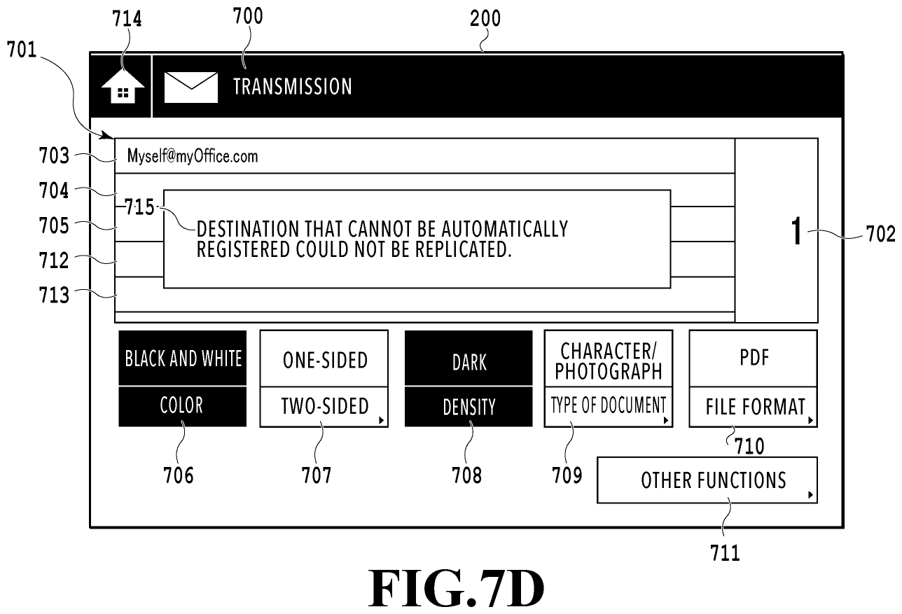

FIGS. 7A to 7D are diagrams illustrating the transmission screen 700 in the present embodiment. The transmission screen 700 includes a destination display region 701 to display the transmission destination and a button to perform setting and the like. A transmission destination number display region 702 indicates the current number of the transmission destinations. As buttons to set transmission functions that are included in the transmission screen 700, there are a color selection button 706, a two-sided button 707, a density button 708, a document type button 709, and a file format 710. Hereinafter, the buttons described above are collectively referred to as a setting button. Other transmission functions are gathered in a screen displayed by an other functions button 711. A home button 714 is a button to return to the home screen.

As illustrated in FIG. 7A, currently, the destination display region 701 displays “SalesManager[0043]myOffice.com”, “SalesManager[0044]myOffice.com”, and “Myself[0045]myOffice.com”. Additionally, it can be seen from the displayed setting button that it is a state of scanning with settings of a color of “black and white”, “two-sided reading”, a density of “normal”, a document type of “character photograph document”, and a file format of “PDF”.

In S602, the CPU 100 determines whether the start key 201 is pressed in a state in which the document to be read is put on a platen glass. If it is determined that the start key 201 is not pressed, the CPU 100 waits until the start key 201 is pressed. If it is determined that the start key 201 is pressed, the CPU 100 allows the process to proceed to S603.

In S603, the CPU 100 executes the job according to the setting. Specifically, first, reading of the document by a scanner unit included in the image processing unit 13 is executed with the set setting value. After the reading is completed, the image processing unit 13 generates an output image. In this process, the image processing unit 13 reflects the function related to the set image on the output image and outputs PDF format data based on the input document.

In S604, the CPU 100 saves the setting of the job in a memory region of the transmission function of the HDD 103. Thereafter, the CPU 100 ends the processing in the present flowchart. The above descriptions are the basic flowchart to execute the job.

Next, details of saving the job setting in S604 are described. Conventionally, a function of saving the setting of the job that is set once and calling the saved job the next time to save the effort of setting again has been used in general. On the other hand, since there is also the transmission destination left in the saved job setting, there may be a case of occurrence of wrong transmission in which the job is transmitted to a destination that the user does not intend. There is a possibility of occurrence of a negative cycle in which the user avoids using the saved job setting again to avoid the wrong transmission and performs the setting manually every time even if it is the same setting. A method of saving the destination to solve the above-described negative cycle is described below.

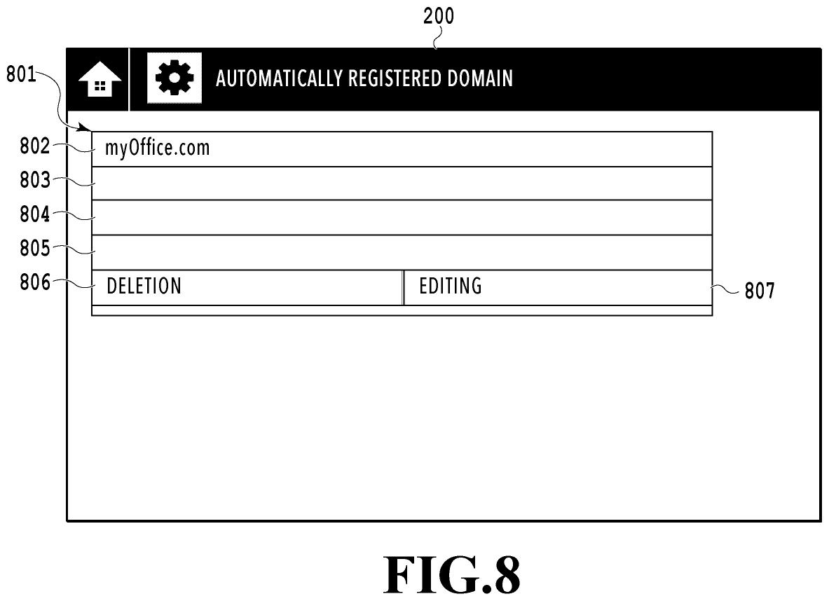

FIG. 8 is a diagram illustrating an automatically registered domain screen. In FIG. 5A, in a case where the automatically registered domain button 506 is pressed, the automatically registered domain screen illustrated in FIG. 8 is displayed. In this example, “myOffice.com” is registered with a list 802 in a registered domain list 801. Additionally, nothing is registered with lists 803 to 805 yet, and it is possible to display a not-illustrated keyboard screen by selecting the lists 803 to 805 and to set a new automatically registered domain. That is, it is possible to register two or more automatically registered domains. It is also possible to read out an operation menu for the domain by swiping each line of the registered domain list to the right and the left. In the present embodiment, it is possible to select a deletion button 806 to delete the domain set in the line and an editing button 807 to edit the domain registered with the line. In a case where the edit button 807 is selected, the not-illustrated keyboard screen is displayed with the domain set in the line as initial setting. Additionally, in this list, the lines are scrolled by an flick operation.

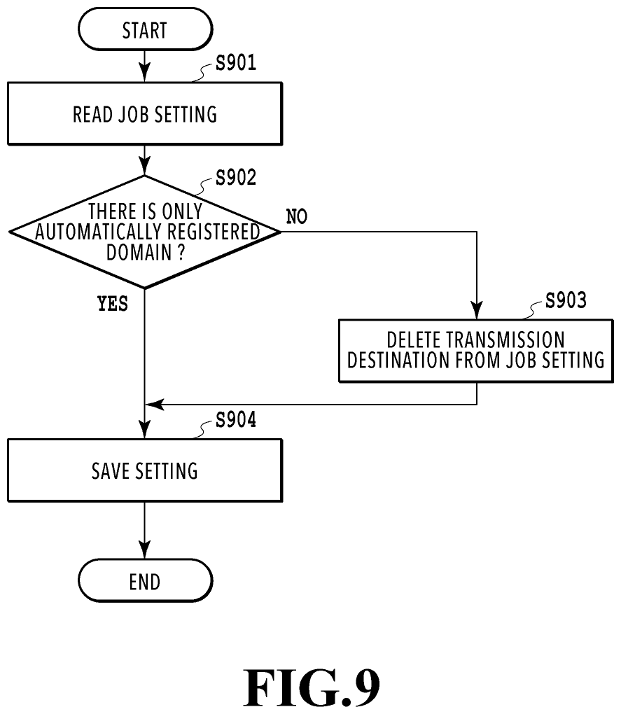

FIG. 9 is a flowchart illustrating details of the processing in S604 in FIG. 6. In S901, the CPU 100 reads the setting of the job executed in S603. In S902, the CPU 100 determines whether the transmission destination is comparable to (corresponds to) the automatically registered domain registered in advance. That is, whether the transmission destination is comparable to the automatically registered domain is determined by comparing the domain registered with the registered domain list 801 in FIG. 8 to the inputted transmission destination illustrated in FIG. 7. If there is included at least one destination not comparable to the automatically registered domain, the CPU 100 allows the process to proceed to S903. If all the destinations are comparable to the automatically registered domain, the CPU 100 allows the process to proceed to S904.

The determination processing in S902 is performed by comparing a character string after “[0053]” of the transmission destination to a character string of the automatically registered domain (in the example in FIG. 8, “myOffice.com”). It is possible to set as the transmission destination not only an e-mail but also a URL of a folder. In a case where the transmission destination does not include “[0054]”, a character string from//to the next/is compared to the character string of the automatically registered domain from the right to see whether they match. For example, in a case where the transmission destination is “http://www.myOffice.com/myFolder”, “www.myOffice.com” and the automatically registered domain are compared. Additionally, in a case where the transmission destination is “https://server.www.myOffice.com/myFolder”, “server.www.myOffice.com” and the automatically registered domain are compared. In these examples, both the cases match the automatically registered domain.

In a case of the setting in FIGS. 7A and 8, “myOffice.com” is registered with the registered domain list. Additionally, the inputted destinations are “SalesManager[0056]myOffice.com”, “FieldEngineer[0057]myOffice.com”, and “Myself[0058]myOffice.com”. Accordingly, it is determined that all the destinations match the automatically registered domain, and the CPU 100 allows the process to proceed to S904.

In S903, the CPU 100 deletes the transmission destination from the job setting. In S904, the CPU 100 saves the job setting in the memory region of the transmission function of the HDD 103. That is, in a case where the transmission destination not comparable to the automatically registered domain is included in the job setting, the CPU 100 saves the job setting from which the transmission destination is deleted in the HDD 103. On the other hand, in a case where all the transmission destinations in the job setting are comparable to the automatically registered domain, the job setting is saved in the HDD 103 without deleting the transmission destination. In a cases of the setting in FIGS. 7A and 8, since all the transmission destinations are comparable to the automatically registered domain, the job setting is saved in the HDD 103 without deleting the transmission destination. Thereafter, the CPU 100 ends the processing in the present flowchart.

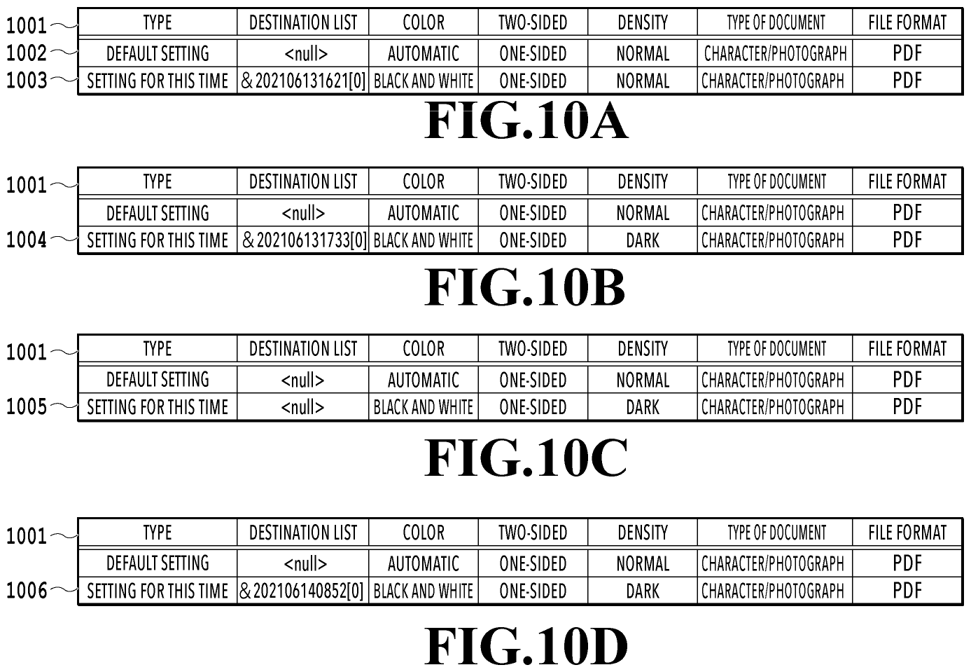

FIGS. 10A to 10D are diagrams illustrating a data table of the job setting saved in the memory region of the transmission function of the HDD 103. This data table is a table to record the setting value of the application. FIG. 10A illustrates a data table of the job that is set and executed in FIG. 7. As illustrated in a header 1001 of the data table in FIG. 10A, a default setting value of the transmission function is saved in default setting 1002 in a first line, and the setting of the job executed this time is added and saved in setting for this time 1003 in a second line. That is, information that is set for the job setting is added. In a destination list, a link to the character string is shown. In the destination list of the setting for this time 1003, “&202106131621[0]” is shown as the link to the character string. The shown data is stored in an xml format in reality, and FIG. 10A is saved in the memory region of the transmission function of the HDD 103 as a data1.xml file.

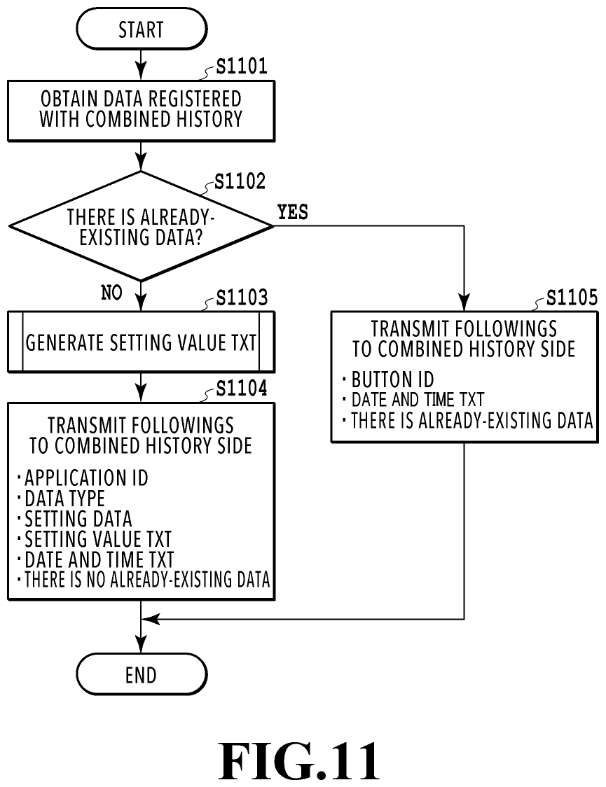

FIG. 11 is a flowchart illustrating generation of displayed contents in a case where the image processing apparatus 1 adds the job history to the combined history display region 509. The processing in the present flowchart is started based on ending of the processing of executing the job in FIG. 6. In the descriptions below, the job that is executed in FIG. 6 is referred to as a “job executed for this time”.

In S1101, after the job ends in FIG. 6, the CPU 100 obtains information to display the job history in the combined history display region 509 saved in the HDD 103.

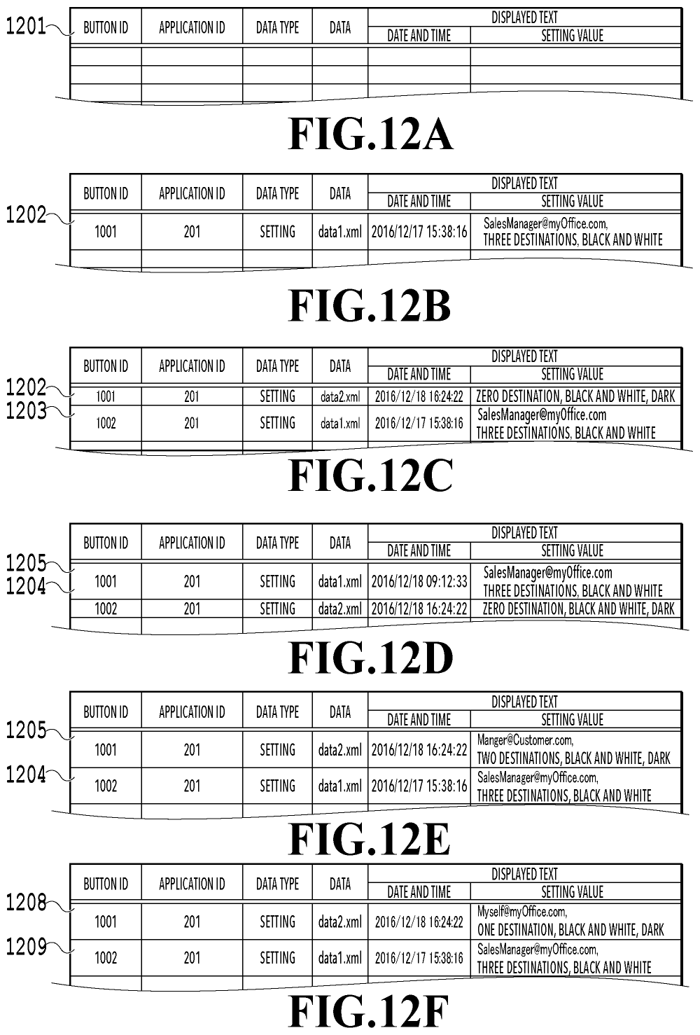

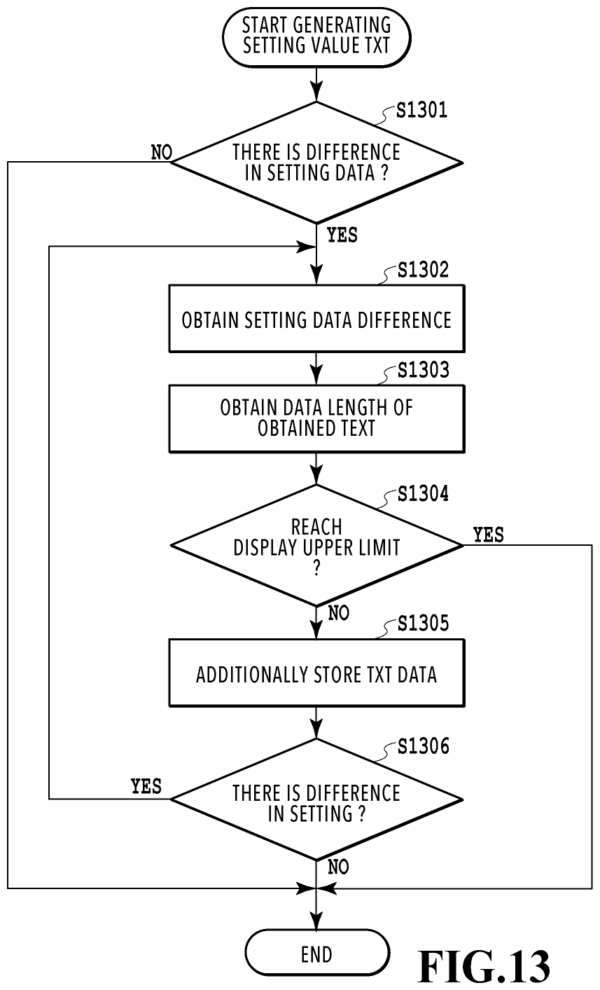

FIGS. 12A to 12F are diagrams illustrating data table including the information to display the job history in the combined history display region 509. This is also called a data table of the combined history. In the present embodiment, a “button ID”, an “application ID”, a “data type”, “raw data of setting value set by application”, and “text data related to date and time and setting value” are stored in the data table illustrated in FIG. 12A. The “button ID” is an ID to identify the history registered with the combined history. The “application ID” is an ID to identify which application executed the job that is the history registered with the combined history. Additionally, the ID is determined in advance for each application such as “100” for an application of managing the apparatus itself, “101” for copying, and “201” for transmission. The “data type” is to identify the type of the data main body described later, and in a case where the “data type” is “setting”, it indicates the job setting data.

“Data” is raw data of the job setting executed by the application. For example, for the application of the transmission 502, the data is a file of an xml format including the function and the setting value to be set by the application that indicate the transmission destination list, the color, or whether it is two-sided reading. “Date and time” of “displayed text” is a date and time at which the job is executed and is text data displayed in the combined history display region 509. “Setting value” of the “displayed text” is a characteristic message indicating text data that picks up characteristic setting from the settings of the executed job and is also displayed in the combined history display region 509. The texts of the date and time and the setting value fill the important role for the user to remember what the job setting is about by looking at the combined history display region 509. In a case where there is already-saved data in the data table of the combined history, the image processing apparatus 1 obtains all the data of the job history matching the application ID.

In S1102, the CPU 100 determines whether there is the already-existing data that is data of the same setting as the data of the job executed for this time in the data table obtained in S1101. If it is determined that there is the already-existing data, the CPU 100 allows the process to proceed to S1105. If it is determined that there is no already-existing data, the CPU 100 allows the process to proceed to S1103.

In S1103, the CPU 100 generates a new setting value text since there is no already-existing data. The setting value text is the displayed text of the setting value in the data table of the combined history illustrated in FIG. 10. Details of the processing in S1103 are described later with reference to FIG. 13. In S1104, the CPU 100 transmits information to display the job history in the combined history display region 509 to the image processing apparatus 1. The information for the CPU 100 to display the job history in S1104 includes “application ID”, “data type”, “setting data”, “setting value text”, “date and time text”, and “information indicating that there is no already-existing data”. With confirmation of the “information indicating that there is no already-existing data”, it is possible to determine whether to add a new data table or update a date of the already-existing data table in a case of processing of updating the data table of the combined history that is described later. Thereafter, the processing in the present flowchart ends.

In S1105, the CPU 100 transmits the information to display the job history to the image processing apparatus 1. The information to display the job history that is transmitted by the CPU 100 in S1105 includes “button ID”, “date and time text”, and “information indicating that there is no already-existing data”. Thereafter, the CPU 100 ends the processing in the present flowchart.

FIG. 13 is a flowchart illustrating the details of S1103 in FIG. 11. This operation is described with reference to FIG. 10A.

In S1301, the CPU 100 of the image processing apparatus 1 compares the setting for this time 1003 to the setting value of the default setting 1002 and determines whether there is a different portion. This comparison is performed sequentially from the left side of the items of the setting values in FIG. 10A. That is, in a case of FIG. 10A, the comparison starts from the “destination list” sequentially. As a result of the comparison, if it is determined that there is one or more differences, the CPU 100 allows the process to proceed to S1302. If it is determined that there is no difference, the CPU 100 ends the processing in the present flowchart. The reason for picking up the difference between the setting for this time and the default setting 1002 is because it is possible to assume that the item with the setting value that is changed intentionally by the user is more memorable. For transmission setting, since there is <null> indicating that no transmission destination is set by default, the transmission destination and the number of the transmission destinations inevitably have a difference. For other settings, in a case of the setting for this time, since there is firstly a difference in the color setting, the text of the setting value that the image processing apparatus 1 obtains first is “black and white”.

In S1303, the CPU 100 obtains a data length of the setting value text. In S1304, the CPU 100 determines whether the setting value text reaches a predetermined display upper limit. Since the job history displayed in the combined history display region 509 has a limitation in the length of the text to be displayed, whether the data length reaches the display upper limit is determined in this step. If it is determined that the data length exceeds the display upper limit, the CPU 100 ends the processing in the present flowchart without adding the text data. If it is determined that the data length does not reach the upper limit, the CPU 100 allows the process to proceed to S1305.

In S1305, the CPU 100 adds the read text data as the text data of the setting value to be displayed by the image processing apparatus 1 in the combined history display region 509. In S1306, the CPU 100 determines whether there is a difference in the setting in another portion. If it is determined that there is the difference, the CPU 100 allows the process to return to S1302. Since there is the difference in only the color setting in the job for this time (FIG. 10A), the CPU 100 generates the text data of only “black and white”. The application ID of the application side executed by the image processing apparatus 1 and the setting data for this time saved in the HDD 103 in S604 in FIG. 6 are saved as data1.xml. In addition, the generated setting value text, a text of the job execution date and time, and the information indicating whether there is the already-existing data are saved in the HDD 103 and transmitted to the combined history executed by the image processing apparatus 1. The information indicating whether there is the already-existing data is information updated based on a result of the comparison in S1102. For example, in the combined history display region 509 illustrated in FIG. 5A, there is no data in the data table saved for the combined history, and it is determined that there is no already-existing data; for this reason, no job history is displayed.

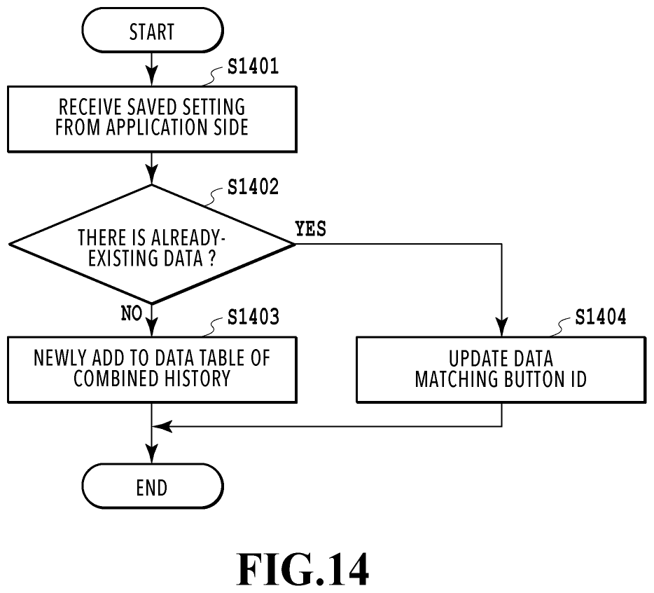

FIG. 14 is a flowchart of updating the displayed contents of the job history to be displayed in the combined history display region 509 in a case where the image processing apparatus receives the setting information data. In S1401, the CPU 100 receives the setting saved in the HDD 103 in S904 in FIG. 9 from the application side executed by the CPU 100. In S1402, the CPU 100 checks whether there is the already-existing data. It is possible to determine based on which of “information indicating there is the already-existing data” and “information indicating there is no already-existing data” is received. If it is determined that there is the already-existing data, the CPU 100 allows the process to proceed to S1404. If it is determined that there is no already-existing data, the CPU 100 allows the process to proceed to S1403. In S1403, the CPU 100 adds new data received from the application side to the data table of the combined history. Note that, the data received from the application side is added to the data table of the combined history. Thus, the data table of the combined history transitions from a state illustrated in FIG. 12A to a state in which the history data is added to a line 1202 as illustrated in FIG. 12B. In S1404, the CPU 100 updates only a date of the data table matching the button ID. Thereafter, the CPU 100 ends the processing in the present flowchart.

Thereafter, in a case where the user performs an operation to display the home screen, the CPU 100 displays a job history for this time 510 in the combined history display region 509 as illustrated in FIG. 5B. In the job history for this time 510, an icon 511 of the application identified from the application ID, a job execution date and time 512, and a text 513 indicating the difference from the default setting are displayed. This information is important information for helping the user remember what the setting is about by looking at the job history for this time 510. In a case where execution of the job by using the same setting is demanded, processing of calling the application while reflecting the same setting for the combined history is performed by the user pressing the job history 510.

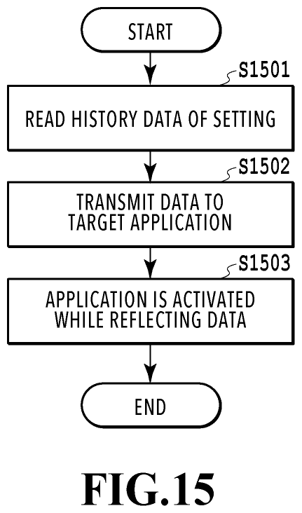

FIG. 15 is a diagram illustrating a flowchart in a case of calling the application from the combined history. The processing in the present flowchart starts in a case where the job history of the combined history display region 509 is selected by the user. In the present embodiment, it is described under the assumption that the job history 510 is pressed by the user in the combined history display region 509 in FIG. 5B.

In S1501, the CPU 100 reads the job setting corresponding to the button ID of the pressed job history 510 from the data table of the combined history saved in the HDD 103. In S1502, the CPU 100 identifies the target application from the “application ID” included in the read job setting and transmits the setting data to the application. In this case, since the application is “transmission”, the application of transmission is called. Additionally, “data1.xml” that is the setting data corresponding to the job history 510 is transmitted to the transmission application. In S1503, the application of transmission that operates on the CPU 100 displays the screen of the application on the touch panel 200 in a state in which setting values of various settings are read based on the received data1.xml and the settings are reflected. Thereafter, the CPU 100 ends the processing in the present flowchart. FIG. 7A is the transmission screen displayed while reflecting the setting of the job history 510. In this screen, since all the transmission destinations are the destination corresponding to the automatically registered domain, the settings including the destination that correspond to the job history 510 are all reflected. The user thus can replicate the transmission setting comfortably and easily. Therefore, for the setting of the job corresponding to the job history, it is possible to replicate the setting executed once by one button.

Next, a case where the user changes a part of the setting from the processing described in FIG. 15 and the job is executed is described. The changed portion is deletion

of the two transmission destinations, which are “SalesManager[0077]myOffice.com”, and “FieldEngineer[0078]myOffice.com”, from the above-mentioned setting. Additionally, “Manager[0079]Customer.com” is added. Moreover, the reading density is changed to “dark”. That is, the user presses the start key 201 with the setting illustrated in FIG. 7B. In the CPU 100 in S603 in FIG. 6, the application operating on the CPU 100 executes the job according to the contents of the setting. In S604, the CPU 100 overwrites and saves the setting in the job execution as illustrated in a line 1004 of the setting for this time in a second line in FIG. 10B. Once the saving ends, in S901 in FIG. 9, the CPU 100 reads the job setting for this time. That is, the CPU 100 reads the job setting illustrated in FIG. 10B. In S902, the CPU 100 determines whether all the transmission destinations are comparable to the automatically registered domain. In a case of the setting in this time, since “Manager[0080]Customer.com” is not the automatically registered domain, in S904, the CPU 100 deletes the transmission destination from the job setting and saves the setting in the memory region of the transmission function of the HDD 103.

FIG. 10C illustrates the data table saved in the memory region of the transmission function of the HDD 103 in the above-described state. It can be seen that the transmission destination is stored as <null> although the setting of the job executed for this time is added and saved in a line 1005 of the setting for this time. The setting data in FIG. 10C is saved in the memory region of the transmission function of the HDD 103 as a data2.xml file.

Hereinafter, as with the above description, in the flowchart in FIG. 11, the data already in the combined history is compared to the setting data for this time. Since there is no setting for this time in the already-existing data, the text of the setting difference is generated in the flowchart in FIG. 13, and the various data are transmitted to the combined history. Thereafter, in the flowchart in FIG. 14, the history of new setting is added. A button ID 1203 in FIG. 12C indicates the history newly added to the data table. Additionally, a job history 514 in FIG. 5C is the job history newly displayed in the combined history display region 509 of the home. The job history is displayed with sorted in descending order of the execution date and time of the job, and the job history newly added is added as the first item on the list as illustrated in FIG. 5C.

Therefore, it is possible to reduce the effort of the job setting of the user by using (diverting) the setting value of the job setting that is used once by the user as the setting value of the new job. In this case, a mark 522 indicating that the destination is not saved as illustrated in FIG. 5G may be added to the screen in FIG. 5C.

In a case where the job history 510 of the transmission executed first is selected in FIG. 5C, and the job is executed without changing the setting, it is determined as “there is the already-existing data” in the determination on whether there is the already-existing data in the combined history. Therefore, the processing of generating the text illustrated in S903 is not executed. Accordingly, the date and time text and the information indicating that there is the already-existing ID and the data indicating which the button ID of the combined history is are transmitted from the application side to the combined history. Additionally, since it is also determined as “there is the already-existing data” in S1402 in FIG. 14, the CPU 100 updates and saves only the date of the data matching the button ID in FIG. 12C.

FIG. 12D is data 1205 in which the date is updated. The combined history displays the histories in descending order of dates; for this reason, the data 1205 in which the date is updated this time is moved to the data table as illustrated in FIG. 12D. Additionally, a job history 516 of a later execution date is displayed at the top of the histories of the setting as illustrated in FIG. 5D. The job execution date and time 512 in FIG. 5B is updated as a job execution date and time 515.

Next, a case where the job corresponding to the job history 514 of transmission in FIG. 5D is called, and the screen returns to the home screen without executing the job is described. In this case, since no job is executed, the processing after the saving of the setting in S604 in FIG. 6 is not performed. Therefore, the update processing of the job history is not performed, and the display remains as FIG. 5D.

Next, registration and deletion of the job history are described. As illustrated in FIG. 5E, the job history displayed in the combined history display region 509 displays a context menu 517 of an operation performed on the job history itself by a long-press operation of the button of the history by the user. Although long-press is described as an example for the user operation to display the context menu 517, how to call the context menu 517 is not limited to long-press and may be double-tap, arranging a button for calling, and the like. As the operation performed on the job history, the context menu 517 includes context menu such as execution 518, registration with menu 519, and deletion 520.

In a case where the execution 518 is selected in FIG. 5E, as described with reference to FIG. 15, the CPU 100 performs calling processing of the application. In a case where the registration with menu 519 is selected in FIG. 5E, processing of registering the custom button as a new button in the menu 500 on the left side is performed by the CPU 100. It is possible to consider processing of setting a position of the job history registered in this case in a blank in the menu 500 or allowing the user to select the position. In a case where the deletion 520 is selected in FIG. 5E, processing of deleting the selected job history is executed by the CPU 100. In this case, the CPU 100 deletes the target from the data table of the combined history in FIG. 12 and executes sorting processing of the remaining histories based on the date and time.

Next, a case where the adding of the combined history reaches the upper limit is described. In a case where the job execution of different settings is performed repeatedly and the number of saving of the combined history reaches the upper limit thereof, processing of sequentially deleting the history from old history in the data table in FIG. 12 is performed by the CPU 100. This upper limit is the upper limit of the storage region and is not necessarily the same as the upper limit of the display region. This is because the upper limit of the display region is variable depending on setting such as button size and layout, or whether it is scrollable with a slider bar or flick.

As described above, according to the present embodiment, it is possible to improve the convenience in the job setting. Specifically, in a case where all the transmission destinations included in the job setting correspond to the automatically registered domain, the transmission destination is displayed without deleting in a case of displaying in the combined history display region 509. Additionally, in a case where there is included the destination not corresponding to the automatically registered domain, the printing job from which the transmission destination is deleted is displayed. Thus, a concern of wrong transmission is solved, and the user can select the printing job used before from the combined history comfortably.

Note that, in the present embodiment, in a case where there is at least one transmission destination not comparable to the automatically registered domain, all the transmission destinations are deleted from the setting of the job regardless of the number of the transmission destinations. However, it is not limited thereto, and a mode in which only the transmission destination corresponding to the automatically registered domain is deleted may be applied, for example.

### Embodiment 2

In the embodiment 1, whether the destination is the automatically registered domain is determined in the process of the registration with the combined history; on the other hand, in the present embodiment, an operation of determining whether the destination is the automatically registered domain in the process of calling the application from the combined history is described in detail.

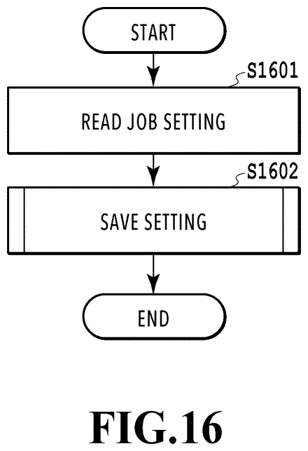

FIG. 16 is a flowchart illustrating details of S604 in FIG. 6 in the present embodiment. In S1601, the CPU 100 reads the job setting executed in S603 in FIG. 6. In S1602, the CPU 100 saves the read job setting in the HDD 103. Thereafter, the CPU 100 ends the processing in the present flowchart. It can be seen from the comparison to FIG. 9 in the embodiment 1 that the processing comparable to the determination processing on whether it is the automatically registered domain (S902) is not performed.

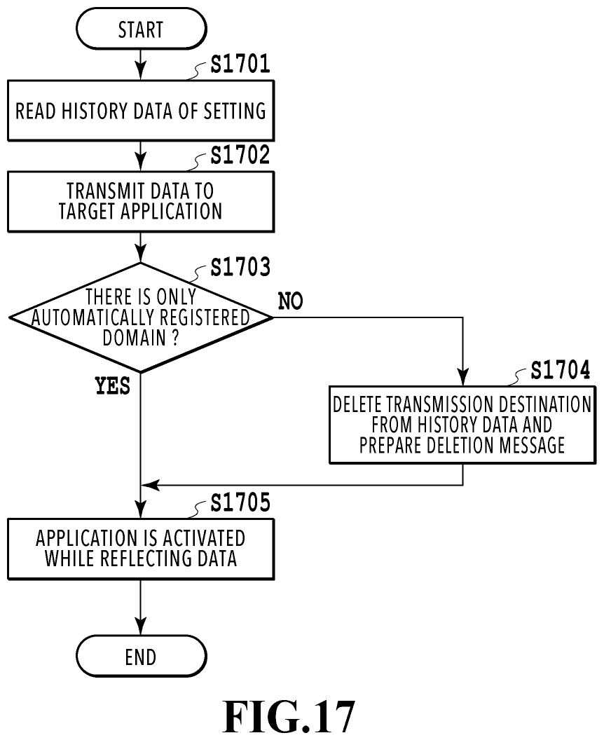

FIG. 17 is a flowchart in a case of calling the application from the combined history in the present embodiment. In S1701, the CPU 100 reads the history data corresponding to the button ID of the job history selected in the combined history display region 509 from the data table of the combined history saved in the HDD 103. In S1702, the CPU 100 transmits the setting of the job to the target application.

In S1703, the CPU 100 determines whether all the transmission destinations included in the setting of the job are the destination comparable to the automatically registered domain. If it is determined that the transmission destinations are only the determination comparable to the automatically registered domain, the CPU 100 allows the process to proceed to S1705. On the other hand, if it is determined that the transmission destination not comparable to the automatically registered domain is included, the CPU 100 allows the process to proceed to S1704.

In S1704, the CPU 100 deletes the transmission destination from the history data and prepares a message notifying of the deletion.

In S1705, the CPU 100 activates the application in a state in which the setting of the job corresponding to the history data is reflected. Thereafter, the CPU 100 ends the processing in the present flowchart. That is, it can be seen from FIG. 17 compared to FIG. 14 in the embodiment 1 that the determination on whether the transmission destination included in the setting job is the automatically registered domain is added in the process of transmitting the data to the application.

FIG. 7B is a diagram illustrating the transmission screen 700 of the transmission application in the present embodiment. In the destination display region 701, “Manager[0099]Customer.com” and “Myself[0100]myOffice.com” are inputted. Assuming that the user sets the setting in FIG. 7B, and the user presses the start key 201, the application operating on the CPU 100 executes the job according to the contents of the setting. The CPU 100 overwrites and saves the setting in the job execution as illustrated in the line 1004 of the setting for this time in the second line in FIG. 10B.

Thereafter, after the above-described processing in FIGS. 9, 11, 12, and 16, the CPU 100 displays the executed job history in the combined history display region 509. The data table of the combined history in this state is illustrated in FIG. 12E. Additionally, the combined history display region 509 is illustrated in FIG. 5F. In a case where a job history 521 displayed by the user operation is selected, the activated application of the transmission 502 displays the transmission screen 700 as illustrated in FIG. 7C. As illustrated in FIG. 7C, the destination is deleted from the destination display region 701, and a message 714 notifying of the deletion of the destination is displayed.

This is displayed because “Manager[0102]Customer.com” out of the two transmission destinations is not comparable to the automatically registered domain “myOffice.com” registered in advance in FIG. 8 based on the processing illustrated in FIG. 17.

As above, according to the present embodiment, it is possible to improve the convenience in the job setting. Specifically, in a case where the job including the transmission destination not comparable to the automatically registered domain is executed and is selected as the job history, the setting screen of the application is displayed in a state in which the setting of the job from which the transmission destination is deleted (not included). In this process, the message notifying of the deletion of the transmission destination is displayed. Thus, the operation load of the user is reduced by avoiding the wrong transmission risk of the user while replicating the other setting.

### Embodiment 3

In the embodiment 2, in a case where there is the transmission destination other than the destination of the automatically registered domain in a case of calling the application, none of the transmission destinations are replicated.

In the present embodiment, an operation in a case where only the transmission destination other than the destination of the automatically registered domain is not replicated in a case of calling the application, but the destination of the automatically registered domain is replicated is described in detail.

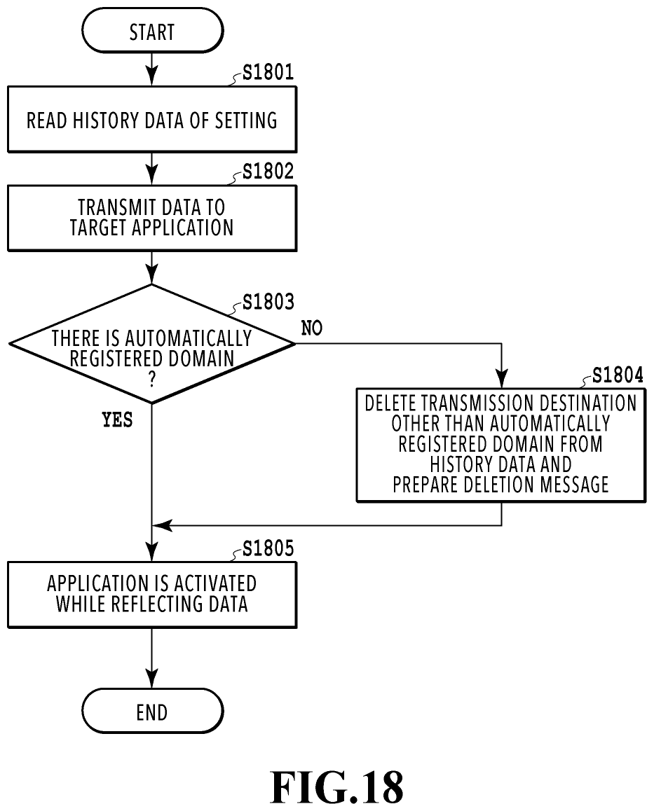

FIG. 18 is a flowchart in a case of calling the application by the combined history in the present embodiment. S1801 to S1803 and S1805 are similar processing as S1701 to S1703 and S1705 in FIG. 17; for this reason, descriptions are omitted. In S1804, the CPU 100 deletes the transmission destination not comparable to the automatically registered domain from the history data. Additionally, a deletion message is prepared.

With the processing in the present flowchart performed, only the transmission destination not comparable to the automatically registered domain is deleted. As with the embodiment 2, in a case where the job is executed with the setting illustrated in FIG. 7B, once the setting of this job is selected from the combined history, the transmission screen 700 illustrated in FIG. 7D is displayed. In FIG. 7D, it can be seen that only the transmission destination comparable to the automatically registered domain is displayed in the destination display region 701, and the transmission destination not comparable to the automatically registered domain is deleted. Additionally, it can be seen that a message 715 is displayed.

As above, in the present embodiment, the operation load of the user is reduced by avoiding the wrong transmission risk while replicating the job setting including the destination comparable to the automatically registered domain.

### Other Embodiments

In the above-described embodiments, whether to delete the transmission destination set to the job is determined by comparing the transmission destination to the domain registered in advance. However, it is not limited thereto, and a configuration in which character string information for excluding the transmission destination including a predetermined character (a character string), which includes a character before in the transmission destination, is obtained and compared to the transmission destination set to the job may be applied, for example. In addition, the information of the automatically registered domain may be included as one of the character string information. Additionally, a series of numbers such as a phone number may be included in the character string information.

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2023-168560, filed Sep. 28, 2023, which is hereby incorporated by reference wherein in its entirety.

What is claimed is:

1. An image processing apparatus, comprising at least one memory and at least one processor and/or at least one circuit which function as:
an execution unit configured to execute a job;
a first obtainment unit configured to obtain character string information including a predetermined character string;
a second obtainment unit configured to obtain setting information corresponding to the executed job;
a saving unit configured to, in a case where a destination included in the setting information is a destination corresponding to the predetermined character string, save the setting information including the destination as job history information, and in a case where at least one or more destinations included in the setting information are a destination not corresponding to the predetermined character string, save the setting information not including the destination not corresponding to the predetermined character string as the job history information; and
a display control unit configured to display the job history information in a predetermined display region.

2. The image processing apparatus according to claim 1, wherein
the display control unit displays the job history information on a predetermined screen including a region in which a function that the image processing apparatus has can be selected and the predetermined display region.

3. The image processing apparatus according to claim 1, wherein
in a case where the job history information is selected in the predetermined display region, the display control unit displays a setting screen of a function corresponding to the job history information in a state in which setting information corresponding to the job history information is reflected.

4. The image processing apparatus according to claim 1, wherein
a difference between a setting value of a function of executing a job corresponding to the job history information and setting information corresponding to the job history information is displayed in the predetermined display region.

5. The image processing apparatus according to claim 1, wherein
the job is executed by a scanning function.

6. The image processing apparatus according to claim 1, wherein
in a case where the at least one or more destinations included in the setting information do not correspond to the predetermined character string, the saving unit saves the setting information not including all destinations including the destination not corresponding to the predetermined character string as the job history information.

7. The image processing apparatus according to claim 1, wherein
the display control unit displays in the predetermined display region the setting information not including the destination not corresponding to the predetermined character string and a mark indicating that the destination not corresponding to the predetermined character string is not included.

8. The image processing apparatus according to claim 1, wherein
the character string information includes a predetermined domain.

9. The image processing apparatus according to claim 8, wherein
it is possible to register the one or more predetermined domains.

10. An image processing apparatus, comprising at least one memory and at least one processor and/or at least one circuit which function as:
an execution unit configured to execute a job;
a saving unit configured to save setting information including a destination of the executed job as job history information;
a display control unit configured to display the job history information in a predetermined display region;
a reception unit configured to receive selection of the job history information displayed in the predetermined display region;
an obtainment unit configured to obtain character string information including a predetermined character string; and
a setting display unit configured to, in a case where the destination included in the setting information corresponding to the selected job history information received by the reception unit corresponds to the predetermined character string, display a setting screen of a function corresponding to the job history information that includes a destination corresponding to the predetermined character string, and in a case where at least one or more destinations included in the setting information corresponding to the job history information do not correspond to the predetermined character string, display a setting screen of a function corresponding to the job history information that does not include a destination not corresponding to the predetermined character string.

11. The image processing apparatus according to claim 10, wherein
in a case where the at least one or more destinations included in the setting information corresponding to the job history information do not correspond to the predetermined character string, the display control unit displays the setting information not including all destinations including the destination not corresponding to the predetermined character string.

12. The image processing apparatus according to claim 11, wherein
in a case of displaying the setting screen of the function corresponding to the job history information that does not include the destination not corresponding to the predetermined character string, the display control unit displays a notification indicating that the destination not corresponding to the predetermined character string is not included.

13. The image processing apparatus according to claim 10, wherein
in a case where the at least one or more destinations included in the setting information corresponding to the job history information do not correspond to the predetermined character string, the display control unit displays the setting information not including the destination not corresponding to the predetermined character string.

14. The image processing apparatus according to claim 13, wherein
in a case of displaying the setting screen of the function corresponding to the job history information that does not include the destination not corresponding to the predetermined character string, the display control unit displays a notification indicating that the destination not corresponding to the predetermined character string is not included.

15. The image processing apparatus according to claim 10, wherein
a difference between a setting value of a function of executing a job corresponding to the job history information and setting information corresponding to the job history information is displayed in the predetermined display region.

16. The image processing apparatus according to claim 10, wherein
the job is executed by a scanning function.

17. The image processing apparatus according to claim 10, wherein
the character string information includes a predetermined domain.

18. The image processing apparatus according to claim 17, further comprising:
a registration unit configured to be able to register the one or more predetermined domains.

19. A method of controlling an image processing apparatus, comprising:
executing a job;
obtaining character string information including a predetermined character string;
obtaining setting information corresponding to the executed job;
in a case where a destination included in the setting information is a destination corresponding to the predetermined character string, saving the setting information including the destination as job history information, and in a case where at least one or more destinations included in the setting information are a destination not corresponding to the predetermined character string, saving the setting information not including the destination not corresponding to the predetermined character string as the job history information; and
displaying the job history information in a predetermined display region.
